(19) United States
(12) Patent Application Publication
(10) Pub. No.: US 2026/0365766 A1
(43) Pub. Date: Nov. 19, 2026

(54) PROCESS FOR PRODUCING POLYETHYLENE WITH HIGH PRESSURE CENTRIFUGAL SEPARATION

(71) Applicant: DOW GLOBAL TECHNOLOGIES LLC, Midland, MI (US)

(72) Inventors: Hamed Eghbali, Evergem (BE); Christopher R. Eddy, Lake Jackson, TX (US); Bjorn Altendorf, Halle (DE); Joerg Heinrich, Leipzig (DE); Emile Dupre, Orange, TX (US)

(73) Assignee: Dow Global Technologies LLC, Midland, MI (US)

(21) Appl. No.: 19/129,923

(22) PCT Filed: Nov. 28, 2023
(86) PCT No.: PCT/US2023/081312

§ 371 Date: May 14, 2025

Related U.S. Application Data
(60) Provisional application No. 63/385,500, filed on Nov. 30, 2022.

(51) Int. Cl. C08F 110/02

(52) U.S. Cl. CPC C08F 110/02; C08F 2400/04

(57) ABSTRACT

Embodiments of a process for producing polyethylene comprises: introducing a monomer feed stream comprising ethylene monomer and optionally comonomer to a compressor system to generate high pressure ethylene stream having a pressure of at least 1,000 bar; introducing the high pressure ethylene stream to a high pressure centrifugal separation unit, wherein the high pressure centrifugal separation unit separates solid particles and droplets from the high pressure ethylene stream to generate an enriched effluent comprising the solid particles and droplets and an upgraded high pressure ethylene stream comprising the remainder of the high pressure ethylene stream; withdrawing the enriched effluent from the high pressure centrifugal separation unit; and introducing the upgraded high pressure ethylene stream to a polymerization reactor to generate the polyethylene from the upgraded high pressure ethylene stream.

### CROSS-REFERENCE TO RELATED APPLICATIONS

This application claims the benefit of U.S. Provisional Application Ser. No. 63/385,500 filed Nov. 30, 2022, the entire disclosure of which is hereby incorporated herein by reference.

### TECHNICAL FIELD

Embodiments described herein generally relate to production of polyethylene, and specifically relate to low density polyethylene (LDPE) production which include high pressure centrifugal separation of solid particles and droplets from the high pressure ethylene monomer feed.

### BACKGROUND

Polyethylene resins are utilized in a variety of products and may be blended with additives or formed into a polymer blend or composition. The end use of the formed polyethylene or polymer blend may impose purity or quality restrictions on the finally formed product. While preferably polyethylene resins utilized for the production of polyethylene based products are completely pure and without the presence of trace contaminants, such is not realistic in a real-world setting. Consequently, current polyethylene polymerization systems attempt to remove contaminants from the ethylene monomer or monomer blends provided to the reactor where polymerization occurs. Such purification generally occurs prior to increasing the pressure of the ethylene monomer stream using conventional separation techniques, such as gravity separation or swirl tubes. However, purification after pressurization of the ethylene monomer stream has not traditionally been accomplished resulting in the presence of any contaminants introduced in the pressurization process being passed to the reactor where polymerization occurs.

Accordingly, there is a continual need for improved processes for producing polyethylene where contaminants are removed from the ethylene monomer stream after pressurization of the same.

### SUMMARY

Embodiments of the present disclosure meet this need for a process of producing polyethylene where contaminants are removed from the ethylene monomer stream after pressurization of the same. Specifically, embodiments of the present disclosure achieve this by utilizing a high pressure centrifugal separation unit positioned subsequent to a compressor system which elevates the pressure of a monomer feed stream comprising ethylene monomer. Such arrangement allows for the removal of particles or contaminants introduced into the monomer feed stream from the compressor system.

According to one embodiment, a process for producing polyethylene is provided. The process comprises: introducing a monomer feed stream comprising ethylene monomer and optionally comonomer to a compressor system to generate high pressure ethylene stream having a pressure of at least 1,000 bar; introducing the high pressure ethylene stream to a high pressure centrifugal separation unit, wherein the high pressure centrifugal separation unit separates solid particles and droplets from the high pressure ethylene stream to generate an enriched effluent comprising the solid particles and droplets and an upgraded high pressure ethylene stream comprising the remainder of the high pressure ethylene stream; withdrawing the enriched effluent from the high pressure centrifugal separation unit; and introducing the upgraded high pressure ethylene stream to a polymerization reactor to generate the polyethylene from the upgraded high pressure ethylene stream.

These and further embodiments are described in more detail in the following Detailed Description in conjunction with the appended drawings.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 is a schematic illustration of the present process for producing polyethylene according to one or more embodiments of the present disclosure;

FIG. 2 is a schematic illustration of the present process for producing polyethylene according to one or more embodiments of the present disclosure where a by-pass is provided;

FIG. 3 is a schematic illustration of the present process for producing polyethylene according to one or more embodiments of the present disclosure as illustrated in FIG. 2 where a recycle line is further provided; and

FIG. 4 is a schematic illustration of the present process for producing polyethylene according to one or more embodiments of the present disclosure where an accepts stream from the high pressure centrifugal separation unit is recycled to the compressor system.

### DETAILED DESCRIPTION

Specific embodiments of the present application will now be described. These embodiments are provided so that this disclosure will be thorough and complete and will fully convey the scope of the claimed subject matter to those skilled in the art.

The term “polymer” refers to a polymeric compound prepared by polymerizing monomers, whether of a same or a different type. The generic term polymer thus embraces the term “homopolymer,” which usually refers to a polymer prepared from only one type of monomer as well as “copolymer,” which refers to a polymer prepared from two or more different monomers. The term “interpolymer,” refers to a polymer prepared by the polymerization of at least two different types of monomers. The generic term interpolymer thus includes a copolymer or polymer prepared from more than two different types of monomers, such as terpolymers.

“Polyethylene” or “ethylene-based polymer” shall mean polymers comprising greater than 50% by mole of units derived from ethylene monomer. This includes ethylene-based homopolymers or copolymers (meaning units derived from two or more comonomers). Common forms of ethylene-based polymers known in the art include, but are not limited to, Low Density Polyethylene (LDPE); Linear Low Density Polyethylene (LLDPE); Ultra Low Density Polyethylene (ULDPE); Very Low Density Polyethylene (VLDPE); single-site catalyzed Linear Low Density Polyethylene, including both linear and substantially linear low density resins (m-LLDPE); Medium Density Polyethylene (MDPE); and High Density Polyethylene (HDPE).

The term “composition,” as used herein, refers to a mixture of materials that comprises the composition, as well as reaction products and decomposition products formed from the materials of the composition.

“Blend,” “polymer blend,” and like terms mean a composition of two or more polymers. Such a blend may or may not be miscible. Such a blend may or may not be phase separated. Such a blend may or may not contain one or more domain configurations, as determined from transmission electron spectroscopy, light scattering, x-ray scattering, and any other method known in the art. Blends are not laminates, but one or more layers of a laminate may contain a blend. Such blends can be prepared as dry blends, formed in situ (e.g., in a reactor), melt blends, or using other techniques known to those of skill in the art.

The term “supercritical fluid” as used herein, refers to a substance at a temperature and pressure above its critical point, where distinct liquid and gas phases do not exist, but below the pressure required to compress it into a solid.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

One particularly useful application of embodiments of the disclosed process for producing polyethylene is in the production of cross-linkable polyethylene (XLPE) utilized in the manufacture of extra-high voltage cables, such as 500 kilovolts (kV) power transmission cables. Production of such cables typically includes introduction of additives through compounding or liquid soak to an LDPE base resin and then addition of a vulcanization agent such as a peroxide to enable cross-linking of the polyethylene during the cable manufacturing. It will be appreciated that the smallest impurities can result in cable failure given the extreme operating conditions of such cables. As such, both the base resin and additive package must be free of impurities to avoid inclusion of such impurities in the final cable. However, it was unexpectantly determined that when a new cylinder or packing is introduced as part of routine maintenance of the compressor system for pressurization of the ethylene monomer feed in LDPE production there is a break-in time where sharp peaks are ground off the cylinder or packing which generates small metal particles carried away in the ethylene monomer fed to the polyethylene reactor. These small metal particles must necessarily be removed to achieve LDPE base resin within specification for production of extra-high voltage cables. While this example application and need for purification of ethylene monomer subsequent to pressurization is directed to XLPE for use in extra-high voltage cables, it will be appreciated that such process may be useful and advantageous for other end products as polymer resins free of or with reduced impurities are generally desirable.

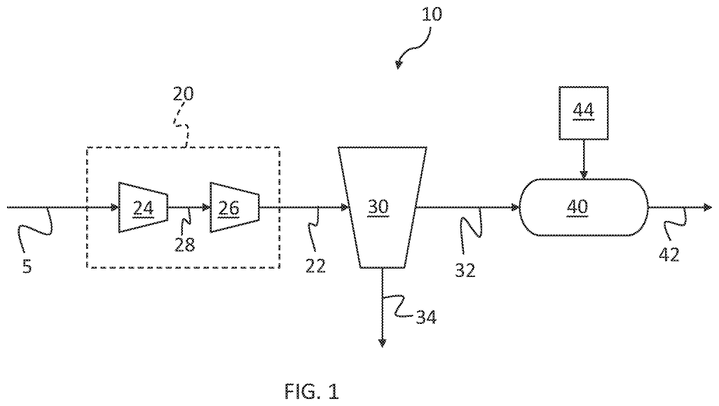

Embodiments of the present process for producing polyethylene will now be described. Referring to the system 10 of FIG. 1, monomer feed stream 5 comprising ethylene monomer is fed to a compressor system 20 to produce a high pressure ethylene stream 22 having a pressure of at least 1000 bar. While not shown, it is contemplated in some embodiments that the monomer feed stream 5 may be pressurized prior to delivery to the compressor system 20. For example, the monomer feed stream 5 may be delivered to the compressor system 20 at a pressure of less than 100 bar, or less than 50 bar, or less than 20 bar. All pressure measurements in the present disclosure are absolute pressure values.

In one or more embodiments, the monomer feed stream 5 may additionally comprise one or more comonomers in combination with the ethylene monomer. Suitable comonomers may include, but are not limited to, ethylenically unsaturated monomers and especially C₃₋₂₀ alpha-olefins, diolefins, polyenes, as well as polar comonomers. These polar comonomers may include but are not limited to those with carboxylic acid, acrylate, or acetate functionality, for example, methacrylic acid, acrylic acid, vinyl acetate, methyl acrylate, isobutylacrylate, n-butylacrylate, glycidyl methacrylate, and monoethyl ester of maleic acid.

Referring again to FIG. 1, the compressor system 20 may comprise one or more compressors in parallel or in series. As shown in FIG. 1, the compressor system 20 may comprise a primary compressor 24 and a secondary compressor 26 downstream of the primary compressor 24. The primary compressor 24 may pressurize the monomer feed stream 5 such that the partially pressurized feed stream 28 to the secondary compressor 26 has a pressure of at least 200 bar. In one or more embodiments, the primary compressor 24 may compress the monomer feed stream 5 to a pressure of 200 to 1000 bar, or from 300 to 900 bar. To achieve this compression, the primary compressor 24 may include one or multiple compression stages.

The secondary compressor 26, which may also be called a hyper compressor, pressurizes the partially pressurized feed stream 28 to a pressure of at least 1000 bar, or at least 2000 bar, or at least 2500 bar, or at least 3000 bar. Like the primary compressor 24, the secondary compressor 26 may include one or multiple compression stages. In one or more embodiments, the secondary compressor 26 may comprise a plunger reciprocating compressor, and can consist of single or multiple compressor stage(s).

In various embodiments, the high pressure ethylene stream 22 exiting the compressor system 20 comprises a pressure of at least 1000 bar, or at least 2000 bar, or at least 2500 bar, or at least 3000 bar. Further, in various embodiments, the high pressure ethylene stream 22 exiting the compressor system 20 may alternatively be defined as having a pressure such that the high pressure ethylene stream 22 is a supercritical fluid.

Referring again to FIG. 1, the high pressure ethylene stream 22 exiting the compressor system 20 is passed to a high pressure centrifugal separation unit 30. The high pressure centrifugal separation unit 30 separates solid particles and droplets from the high pressure ethylene stream 22 to generate an enriched effluent 34 comprising the solid particles and droplets and an upgraded high pressure ethylene stream 32 comprising the remainder of the high pressure ethylene stream. In conformity with terms understood within the art the enriched effluent 34 may be considered the rejects or rejects stream and the upgraded high pressure ethylene stream 32 may be considered the accepts or accepts stream. As such, the enriched effluent 34 may be withdrawn from the high pressure centrifugal separation unit 30 and further processed or disposed of.

It will be appreciated that the enriched effluent 34 may include ethylene, or other liquid or gaseous components, in addition to the solid particles and droplets due to the imperfect separation within the high pressure centrifugal separation unit 30. For example, in continuous operation the enriched effluent may comprise over 99 wt. % of ethylene whereas in batch or semi-batch operation the enriched effluent may comprise up to 50 wt. % ethylene.

In one or more embodiments, the solid particles and droplets are collected in a separate portion of the high pressure centrifugal separation unit 30 for periodic removal. Specifically, the enriched effluent 34 is directed to a storage vessel provided as part of the high pressure centrifugal separation unit 30 where the same is sequestered for periodic drainage or removal.

In one or more embodiments, the solid particles and droplets are withdrawn from the high pressure centrifugal separation unit 30 via a first flow to drive the enriched effluent 34 away from the high pressure centrifugal separation unit 30. Specifically, the enriched effluent 34 and the solid particles and droplets contained within the enriched effluent 34 may be transported away from the high pressure centrifugal separation unit 30 for disposal or further processing. For example, the first flow may be an underflow which removes the solid particles and droplets in a semi-continuous or continuous manner.

In accordance with one or more embodiments, a plurality of high pressure centrifugal separation units 30 are provided. The plurality of high pressure centrifugal separation units 30 may be provided in series or in parallel in accordance with variance embodiments. In various embodiments, the system 10 may include 1, 2, 3, 4, 5, or more than 5 separate high pressure centrifugal separation units 30. It will be appreciated that a plurality of high pressure centrifugal separation units 30 in series allows for progressive purification of the upgraded high pressure ethylene stream 32 through serial removal of the solid particles and droplets. Similarly, it will be appreciated that a plurality of high pressure centrifugal separation units 30 in parallel allows for an increased rate of generation of the upgraded high pressure ethylene stream 32 by leveraging multiple high pressure centrifugal separation units 30 to remove the solid particles and droplets contemporaneously.

In one or more embodiments, the high pressure ethylene stream 22 is introduced into the high pressure centrifugal separation unit 30 in a pulsated manner. Specifically, as will be appreciated by one skilled in the art, the high pressure ethylene stream 22 exiting the compressor system 20 may not be continuous. For example, a reciprocating compressor may generate a flow with a pulsed or non-steady flow rate. As such, the high pressure centrifugal separation unit 30 may be configured to handle the pulsated introduction of the high pressure ethylene stream 22. It will be appreciated that the volume of the high pressure centrifugal separation unit 30 relative to the inlet flow pulsation may be used to tune the impact of the pulsed flow by considering the frequency of the compressor in view of the residence time of the high pressure ethylene stream 22 within the high pressure centrifugal separation unit 30.

Referring again to FIG. 1, the upgraded high pressure ethylene stream 32 exiting high pressure centrifugal separation unit 30 is passed to a polymerization reactor 40 to generate the polyethylene from the upgraded high pressure ethylene stream 32. While any high pressure polymerization reactor may be used in accordance with the present disclosure, examples of specific reactors and reactor types are provided to fully describe the process for producing polyethylene, but the same should not be considered as limiting. In one or more embodiments, the polymerization reactor 40 may be a free radical polymerization reactor. Further, in one or more embodiments a polymerization initiator 44 may be added to the polymerization reactor 40.

The polymerization reactor 40 may include one or more autoclave reactors or tubular reactors. The pressure in each autoclave or tubular reactor zone may be from 1000 to 4000 bar, or from 1500 to 3600 bar, or from 2000 to 3200 Bar. The polymerization temperature in each tubular reactor zone may be from 100 to 400 °C, or from 150 to 360 °C, or from 180 to 340 °C. The polymerization temperature in each autoclave reactor zone may be from 150 to 300, more typically from 165 to 290, and even more typically from 180 to 280 °C.

Referring to FIG. 1, a reactor effluent 42 from the polymerization reactor 40 comprises polyethylene generated in the polymerization reactor 40 as well as unreacted components of the upgraded high pressure ethylene stream 32. It will be appreciated that if polymerization initiator 44 is provided to the polymerization reactor 40 the same may also be present in the reactor effluent 42.

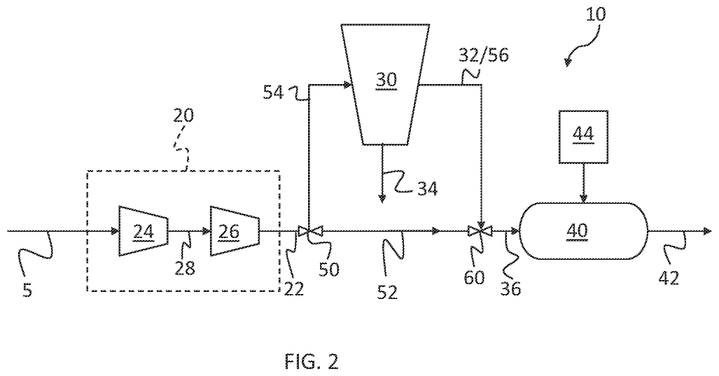

Referring to FIG. 2, in one or more embodiments, the high pressure ethylene stream 22 is provided to a by-pass control valve 50 to controllably direct the high pressure ethylene stream 22 to the high pressure centrifugal separation unit 30 or a by-pass line 52 to directly introduce the high pressure ethylene stream 22 to the polymerization reactor 40. When the by-pass control valve 50 is positioned in a separation mode configuration the high pressure ethylene stream 22 is directed to the high pressure centrifugal separation unit 30 via a separator feed line 54 and the upgraded high pressure ethylene stream 32 from the high pressure centrifugal separation unit 30 is directed to the polymerization reactor 40 via a separator effluent line 56 connected to a reactor inlet line 36. Conversely, when the by-pass control valve 50 is positioned in a by-pass mode configuration the high pressure ethylene stream 22 is directed to the polymerization reactor 40 via by-pass line 52 and the reactor inlet line 36 to directly introduce the high pressure ethylene stream 22 to the polymerization reactor 40. In one or more embodiments, the system 10 may additionally include a backflow control valve 60 provided at the junction of the by-pass line 52 and the separator effluent line 56 to prevent back-flow through the by-pass line 52 in the separation mode configuration and to prevent back-flow through the separator effluent line 56 in the by-pass mode configuration.

With continued reference to FIG. 2, it will be appreciated that the by-pass control valve 50, and the backflow control valve 60 if present, may be configured to allow a split flow of the high pressure ethylene stream 22 such that a portion of the high pressure ethylene stream 22 passes through the high pressure centrifugal separation unit 30 and a remainder of the high pressure ethylene stream 22 is passed directly to the polymerization reactor 40.

In accordance with the embodiments of at least FIG. 2, the system 10 may be operated in separation mode with the high pressure ethylene stream 22 passed through the high pressure centrifugal separation unit 30 for a period after exchange of the cylinder or packing when generation of metal particles during the break-in period are now expected. Subsequent to the break-in period, the system 10 may be change to the by-pass mode configuration where the high pressure centrifugal separation unit 30 is omitted from the process flow as generation of metal particles from the break-in of the cylinder or packing is no longer expected. However, it will be appreciated that the system 10 may still be operated in the separation mode configuration if other solid particles or waxes are anticipated to be present in the high pressure ethylene stream 22 from one or more different sources.

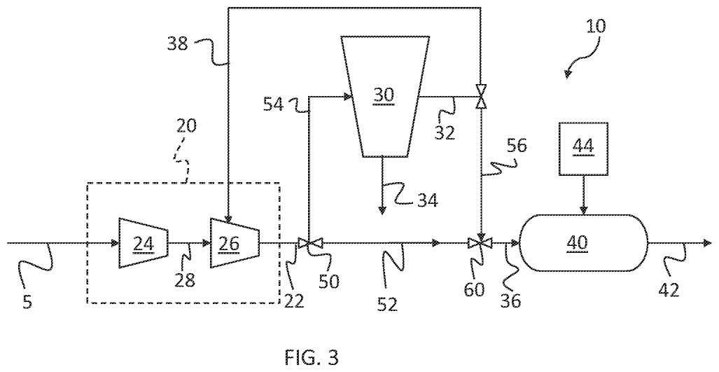

Referring to FIG. 3, the upgraded high pressure ethylene stream 32 is at least partially recycled to the compressor system 20. Specifically, in one or more embodiments, at least a portion of the upgraded high pressure ethylene stream 32 is recycled back to the compressor system 20 via recycle line 38 with the remainder of the upgraded high pressure ethylene stream 32 passed to the polymerization reactor 40 via the separator effluent line 56.

In one or more embodiments, the entirety of the upgraded high pressure ethylene stream 32 is recycled back to the compressor system 20 for at least a period of time. It will be appreciated that recycling at least a portion of the upgraded high pressure ethylene stream 32 back to the compressor system 20 directs such portion of the upgraded high pressure ethylene stream 32 to be passed through the high pressure centrifugal separation unit 30 at least an additional time.

Recycling at least a portion of the upgraded high pressure ethylene stream 32 back to the compressor system 20 allows for repeated separation of the solid particles and droplets from the high pressure ethylene stream 22 to achieve the desired purity or reduction in concentration of the solid particles and droplets in the upgraded high pressure ethylene stream 32 when provided to the polymerization reactor 40.

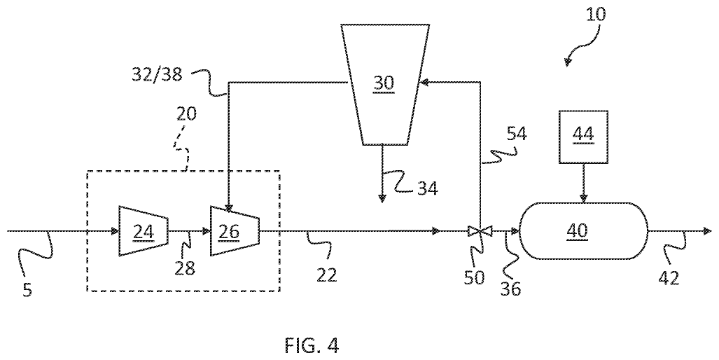

Referring to FIG. 4, the entirety of the upgraded high pressure ethylene stream 32 may be recycled to the compressor system 20 via recycle line 38. Further, by-pass control valve 50 controls the portion of the high pressure ethylene stream 22 provided to the high pressure centrifugal separation unit 30 and the portion of the high pressure ethylene stream 22 provided directly to the polymerization reactor 40. It will be appreciated that the embodiment of FIG. 4 is a variation of the embodiment of FIG. 3.

It will be appreciated that positioning of the high pressure centrifugal separation unit 30 subsequent to the compressor system 20 but prior to the polymerization reactor 40 allows for removal of any solid particles and droplets introduced in the initial stages of the process. However, such removal is also achieved prior to polymerization in the polymerization reactor 40 avoiding challenges associated with separation from a polymer product.

### Solid Particles

In accordance with one or more embodiments the solid particles removed in the enriched effluent 34 are metallic. For example, the solid particles may be copper, bronze, steel, iron, zinc, aluminum, or any other metallic species. In one or more specific embodiments, the solid particles may be filings or other wear products from one or more unit operations processing the components of the monomer feed stream prior to introduction to the high pressure centrifugal separation unit 30. For example, the solid particles may comprises copper or bronze particles worn away from components of the compressor system 20.

In one or more embodiments the solid particles comprise a longest dimension of less than 1,000 microns. In various further embodiments, the solid particles comprise a longest dimension of less than 500 microns, less than 200 microns, less than 150 microns, or less than 100 microns. It will be appreciated that smaller particle sizes present unique challenges in their removal or separation from a stream, which are exacerbated by the high pressures of the current system. However, it will also be appreciated that the processes as discussed in the present disclosure address such challenges in a unique and novel way through implementation of the high pressure centrifugal separation unit 30 between the compressor system 20 and the polymerization reactor 40.

### Droplets

In accordance with one or more embodiments the droplets removed in the enriched effluent 34 comprise waxes. Typically, the waxes are low molecular weight polyethylene that form as droplets or small particles in an ethylene stream.

### Polymers

In one or more embodiments, the polymerization reactor 40 generates low density polyethylene (LDPE) in particular.

In one embodiment, the LDPE has a density from 0.914 to 0.930, more typically from 0.916 to 0.930 and even more typically from 0.918 to 0.926, grams per cubic centimeter (g/cc or g/cm³) prepared according to ASTM D4703 and measured according to ASTM D792, Method B, within one hour of sample pressing. In one embodiment, the LDPE has a melt index (I₂) from 0.1 to 40 g/10 mins, or from 0.2 to 25 g/10 mins measured in accordance to ASTM D-1238 (method B) at 190 °C and at 2.16 kg load. In some embodiments, the LDPE may have a lower I₂ from 0.1 to 10 g/10 mins, or from 0.1 to 1 g/10 mins. Alternatively, the LDPE may have a higher I₂ from 5 to 40 g/10 mins, or from 10 to 25 g/10 mins, or from 15 to 25 g/10 mins.

### Applications

The polyethylene formed in accordance with the presently disclosed processes may be employed in a variety of conventional thermoplastic fabrication procedures to produce useful articles, including, for example, films; molded articles, such as blow molded, injection molded, or rotomolded articles; foams; wire and cable, fibers, extrusion coatings, and woven or non-woven fabrics.

### Examples

To demonstrate the process improvement from integration of the high pressure centrifugal separation unit 30 between the compressor system 20 and the polymerization reactor 40 the reduction in solid particles in the upgraded high pressure ethylene stream 32 entering the polymerization reactor 40 was modeled. The model utilized a smallest particle of 50 μm length, 20 μm width, and 2 μm height which is equivalent to a spherical diameter of 15.6 μm at a concentration of less than 0.1 volume percent of the feed flow. Comparative Example 1 represents no separator provided between the compressor system 20 and the polymerization reactor 40, Comparative Example 2 represents a gravity separator provided between the compressor system 20 and the polymerization reactor 40, and Inventive Example 3 represents a high pressure centrifugal separation unit 30 provided between the compressor system 20 and the polymerization reactor 40.

The results of the simulated separation for each of Comparative Examples 1 and 2 and Inventive Example 3 are provided in Table 1. It is noted that the cut size is present as the d50 value which represents the size particle where a particle separation efficiency of 50% is achieved. Further, the fouling resistance was quantified based on the expected impact of fouling build up on performance characteristics within a typical operation cycle of such a unit. The considered performance characteristics include pressure drop, cut size and safe operation of the unit with a “high” fouling resistance representing no or negligible impact on performance as represented by less than a 5% increase in pressure drop and/or cut size.

TABLE 1
Modeled Separator Performance

| | Removal | | | |
|---|---|---|---|---|
| | Improvement | | | |
| | over | | | |
| | Comparative | Cut Size, d₅₀ | Pressure Drop | Fouling |
| Example | Example 1 | (μm) | (bar) | Resistance |
| Comparative | 0% | >4,000 | 0 | High |
| Example 1 | | | | |
| Comparative | 0% | <4,000 | 2 | High |
| Example 2 | | | | |
| Inventive | 98% | <10 | 4 | High |
| Example 3 | | | | |

It may be noted that the Inventive Example 3 in accordance with the present disclosure demonstrated a 98% particle separation efficiency improvement compared to the base case of Comparative Example 1, a minimal pressure drop, and high fouling resistance.

It will be apparent that modifications and variations are possible without departing from the scope of the disclosure defined in the appended claims. More specifically, although some aspects of the present disclosure may be identified herein as preferred or particularly advantageous, it is contemplated that the present disclosure is not necessarily limited to these aspects.

1. A process for producing polyethylene comprising:
introducing a monomer feed stream comprising ethylene monomer and optionally comonomer to a compressor system to generate high pressure ethylene stream having a pressure of at least 1,000 bar;
introducing the high pressure ethylene stream to a high pressure centrifugal separation unit, wherein the high pressure centrifugal separation unit separates solid particles and droplets from the high pressure ethylene stream to generate an enriched effluent comprising the solid particles and droplets and an upgraded high pressure ethylene stream comprising the remainder of the high pressure ethylene stream;
withdrawing the enriched effluent from the high pressure centrifugal separation unit; and
introducing the upgraded high pressure ethylene stream to a polymerization reactor to generate the polyethylene from the upgraded high pressure ethylene stream.

2. The process of claim 1, wherein the pressure of the high pressure ethylene stream is at least 2,000 bar.

3. The process of claim 1, wherein the high pressure ethylene stream is a supercritical fluid.

4. The process of claim 1, wherein the high pressure ethylene stream is provided to a by-pass control valve to controllably direct the high pressure ethylene stream to the high pressure centrifugal separation unit or a by-pass line to directly introduce the high pressure ethylene stream to the polymerization reactor.

5. The process of claim 1, wherein the upgraded high pressure ethylene stream is at least partially recycled to the compressor system.

6. The process of claim 1, wherein the solid particles and droplets are collected in a separate portion of the high pressure centrifugal separation unit for periodic removal.

7. The process of claim 1, wherein the solid particles and droplets are withdrawn from the high pressure centrifugal separation unit via a first flow to drive the enriched effluent away from the high pressure centrifugal separation unit.

8. The process of claim 1, wherein a plurality of high pressure centrifugal separation units are provided in series or in parallel.

9. The process of claim 1, wherein the solid particles are metallic.

10. The process of claim 9, wherein the solid particles comprise a longest dimension of less than 1,000 microns.

11. The process of claim 9, wherein the solid particles comprise a longest dimension of less than 200 microns.

12. The process of claim 1, wherein the droplets comprise waxes.

13. The process of claim 1, wherein the high pressure ethylene stream is introduced into the high pressure centrifugal separation unit in a pulsated manner.

14. The process of claim 1, wherein the polyethylene is low density polyethylene (LDPE).

15. The process of claim 1, wherein the monomer feed stream introduced to the compresses comprises the ethylene monomer and the comonomer.
